(19) United States
(12) Patent Application Publication
(10) Pub. No.: US 2016/0086064 A1
(43) Pub. Date: Mar. 24, 2016

(54) IMAGE FORMING APPARATUS AND IMAGE PROCESSING APPARATUS

(71) Applicant: FUJI XEROX CO., LTD., Tokyo (JP)

(72) Inventor: Koichi Matsubara, Kanagawa (JP)

(21) Appl. No.: 14/607,108

(22) Filed: Jan. 28, 2015

(30) Foreign Application Priority Data
Sep. 22, 2014 (JP) 2014-193024

(51) Int. Cl. G06K 15/02

(52) U.S. Cl. CPC G06K 15/1827; G06K 15/1805

(57) ABSTRACT

An image forming apparatus includes: an image forming machine that forms an image on a recording material; and an image processing unit that sets different addition/subtraction amounts for thickness of lines constituting bold characters and thickness of lines constituting non-bold characters in changing thickness of lines constituting each character in case where image information for formation of an image by the image forming machine includes bold character information and non-bold character information.

### CROSS-REFERENCE TO RELATED APPLICATIONS

This application is based on and claims priority under 35 USC 119 from Japanese Patent Application No. 2014-193024 filed on Sep. 22, 2014.

### BACKGROUND

1. Technical Field

The present invention relates to an image forming apparatus and an image processing apparatus.

2. Related Art

In electrophotographic, inkjet, and like image forming apparatus such as copiers and printers, an image may be formed by an image forming machine after input image information is subjected to various kinds of image processing. An example of such various kinds of image processing is a character line width adjustment.

### SUMMARY

According to an aspect of the invention, there is provided an image forming apparatus comprising: an image forming machine that forms an image on a recording material; and an image processing unit that sets different addition/subtraction amounts for the thickness of lines constituting bold characters and the thickness of lines constituting non-bold characters in changing the thickness of lines constituting each character in the case where image information for formation of an image by the image forming machine includes bold character information and non-bold character information.

### BRIEF DESCRIPTION OF THE DRAWINGS

FIG. 1 outlines an image forming apparatus according to an exemplary embodiment.

FIG. 2 is a block diagram of a signal processing system of a control unit of the image forming apparatus.

Parts (a) to (f) of FIG. 3 illustrate example processing performed by a line width adjusting unit.

Parts (a) to (d) of FIG. 4 show how character shapes are changed actually when a bold character “F” and a non-bold character “F” are subjected to uniform character thickening processing.

FIG. 5 is a block diagram of a line width adjusting unit used in the exemplary embodiment.

FIG. 6 shows an example picture that is displayed on a UI unit when a user is to input a parameter value.

FIG. 7 is a flowchart showing how the line width adjusting unit operates.

### DESCRIPTION OF SYMBOLS

1 . . . Image forming apparatus; 10 . . . Image forming units; 20 . . . Intermediate transfer belt; 30 . . . Secondary transfer device; 50 . . . Fusing device; 70 . . . Control unit; 72 . . . Line width adjusting unit; 721 . . . Image analysing unit; 722 . . . Parameters acquiring unit; 723 . . . Parameters storage unit; 724 . . . Addition/subtraction amounts calculating unit; 725 . . . Character constructing unit.

### DETAILED DESCRIPTION

An exemplary embodiment of the present invention will be hereinafter described in detail with reference to the accompanying drawings.

### Overall Configuration of Image Forming Apparatus

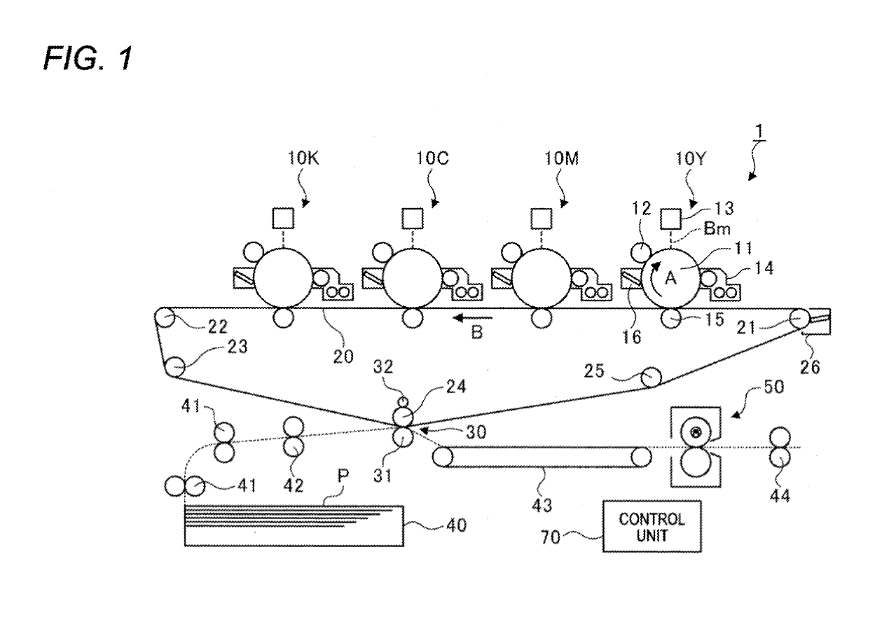

FIG. 1 outlines an image forming apparatus 1 according to the exemplary embodiment. The image forming apparatus 1 is equipped with plural (in the exemplary embodiment, four) image forming units 10 (more specifically, yellow, magenta, cyan, and black image forming units 10Y, 10M, 10C, and 10K) for forming toner images of the respective color components by, for example, electrophotography. The image forming apparatus 1 is also equipped with an intermediate transfer belt 20 to which the toner images of the respective color components formed by the respective image forming units 10 are transferred sequentially (primary transfer). The image forming apparatus 1 is also equipped with a secondary transfer device 30 for transferring (secondary transfer), together, to a sheet P (recording material, recording medium), the toner images transferred to the intermediate transfer belt 20. Furthermore, the image forming apparatus 1 is equipped with a fusing device 50 for fusing the secondary-transferred toner image on the sheet P and a control unit 70 for controlling the individual mechanism units of the image forming apparatus 1.

In the embodiment, the image forming units 10, the intermediate transfer belt 20, the secondary transfer device 30, and the fusing device 50 constitute an image forming machine which forms an image on a sheet P.

The image forming units 10 (10Y, 10K, 10C, and 10K) have the same configuration except for the colors of toners used therein. Therefore, the yellow image forming unit 10Y will be described below as a representative one. The yellow image forming unit 10Y is equipped with a photoreceptor drum 11 which has a photoreceptor layer (not shown), is rotatable in the direction indicated by arrow A, and serves to retain an image. A charging roll 12, an exposing unit 13, a developing device 14, a primary transfer roll 15, and a drum cleaner 16 are disposed around the photoreceptor drum 11.

Among those units and devices, the charging roll 12 is a rotary body which is in contact with the photoreceptor drum 11. The charging roll 12 is connected to a charging power source (not shown), which supplies the charging roll 12 with a positive or negative DC charging bias voltage on which an AC charging voltage having a predetermined frequency is superimposed.

The exposing unit 13 writes an electrostatic latent image on the photoreceptor drum 11 that is charged by the charging roll 12 by means of laser light Bm. The developing device 14 contains a toner of the corresponding color component (a yellow toner because the yellow image forming unit 10Y is being described) and develops the electrostatic latent image formed on the photoreceptor drum 11. The primary transfer roll 15 primary-transfers the toner image formed on the photoreceptor drum 11 to the intermediate transfer belt 20. The drum cleaner 16 removes residues (toners etc.) that remain on the photoreceptor drum 11 after the primary transfer.

The intermediate transfer belt 20 is stretched on plural (in the exemplary embodiment, five) support rolls in a rotatable manner. Among those support rolls, a drive roll 21 not only serves to stretch the intermediate transfer belt 20 but also drives it to rotate it in the direction indicated by arrow B. Stretching rolls 22 and 25 serve to stretch the intermediate transfer belt 20 and rotate as the intermediate transfer belt 20 is driven by the drive roll 21. A correction roll 23 not only serves to stretch the intermediate transfer belt 20 but also functions as a steering roll for restricting a movement of the intermediate transfer belt 20 in the direction that is perpendicular to its conveying direction (i.e., restricting a skew). Thus, the correction roll 23 is disposed so as to be able to incline with its one end in the axial direction as a supporting point. A backup roll 24 not only serves to stretch the intermediate transfer belt 20 but also functions as a component of the secondary transfer device 30.

A belt cleaner 26 for removing residues (toners etc.) that remain on the photoreceptor drum 11 after the secondary transfer is disposed at such a position as to be opposed to the drive roll 21 with the intermediate transfer belt 20 interposed in between.

The secondary transfer device 30 is equipped with a secondary transfer roll 31 which is in pressure contact with the toner image retaining surface of the intermediate transfer belt 20 and the backup roll 24 which is disposed on the back surface side of the intermediate transfer belt 20 and serves as a counter electrode against the secondary transfer roll 31. A voltage supply roll 32 for supplying a secondary transfer bias voltage having the same polarity as the toner charging polarity is disposed so as to be in contact with the backup roll 24. On the other hand, the secondary transfer roll 31 is grounded.

A sheet conveying system is equipped with a sheet tray 40, conveyance rolls 41, registration rolls 42, a conveyance belt 43, and ejection rolls 44. In the sheet conveying system, a sheet P taken out of the sheet tray 40 is conveyed by the conveyance rolls 41 and stopped temporarily at the registration rolls 42. Then the sheet P is sent to the secondary transfer position of the secondary transfer device 30 with predetermined timing. After the secondary transfer, the sheet P is conveyed to the fusing device 50 by the conveyance belt 43. The sheet P that is output from the fusing device 50 is sent to the outside of the machine by the ejection rolls 44.

Next, a basic image forming process of the image forming apparatus 1 will be described. Upon turning-on of a start switch (not shown), a predetermined image forming process is carried out. A specific description will be made below for an example case that the image forming apparatus 1 is a printer. Digital image signals that are input externally (e.g., from a personal computer (PC)) are stored in a memory temporarily. Toner images of the respective colors are formed on the basis of digital image signals of the four colors (Y, M, C, and K) stored in the memory. That is, the image forming units 10 (10Y, 10M, 10C, and 10K) are driven on the basis of the digital image signals of the respective colors. Subsequently, in each image forming unit 10, an electrostatic latent image is formed on the photoreceptor drum 11 that is charged by the charging roll 12 by illuminating it with laser light Bm by the exposing unit 13 according to the digital image signal. The electrostatic latent image formed on the photoreceptor drum 11 is developed by the developing device 14 into a toner image of the corresponding color.

Where the image forming apparatus 1 is a copier, a document sheet that is set on a document stage (not shown) is read by a scanner and resulting reading signals are converted into digital image signals by a processing circuit. And toner images of the respective colors are formed in the same manner as described above.

The toner images formed on the respective photoreceptor drums 11 are sequentially primary-transferred to the surface of the intermediate transfer belt 20 by the primary transfer rolls 15 at the primary transfer positions where the photoreceptor drum 11 are in contact with the intermediate transfer belt 20. On the other hand, toners remaining on the photoreceptor drums 11 after the primary transfer are removed by the drum cleaners 16.

The toner images that have been primary-transferred to so as to be superimposed one on another on the intermediate transfer belt 20 are conveyed to the secondary transfer position as the intermediate transfer belt 20 is rotated. On the other hand, a sheet P is conveyed to the secondary transfer position with predetermined timing and held between the secondary transfer roll 31 and the backup roll 24.

At the secondary transfer position, the toner images retained by the intermediate transfer belt 20 are secondary-transferred to the sheet P through the action of a transfer electric field that is formed between the secondary transfer roll 31 and the backup roll 24. The sheet P to which the toner images have been transferred is conveyed to the fusing device 50 by the conveyance belt 43. In the fusing device 50, the toner image on the sheet P is fused through application of heat and pressure and the sheet P is then sent to an ejected-sheet tray (not shown). On the other hand, toners remaining on the intermediate transfer belt 20 after the secondary transfer are removed by the belt cleaner 26.

### Signal Processing System

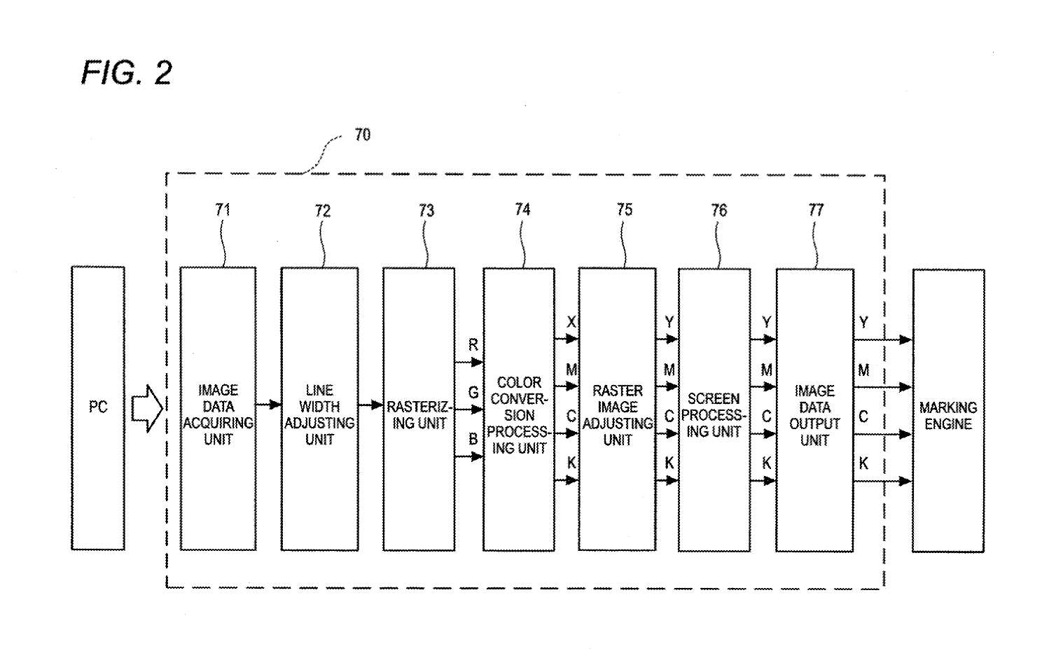

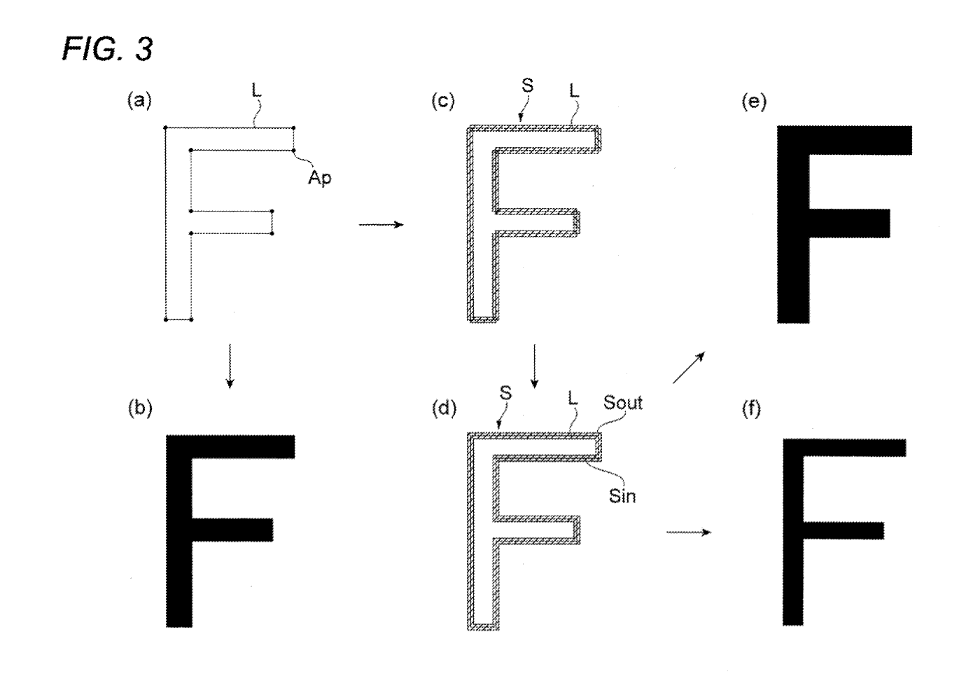

FIG. 2 is a block diagram of a signal processing system of the control unit 70 of the image forming apparatus 1. FIG. 2 shows not only the signal processing system of the control unit 70 but also a personal computer (PC) which is an external apparatus of the image forming apparatus 1 and a marking engine which forms an image on the basis of image signals that have been processed by the signal processing system. For example, the marking engine corresponds to the image forming machine which forms an actual image in the image forming apparatus 1 which has been described above with reference to FIG. 1. This signal processing system is directed to a case that the image forming apparatus 1 is a printer. How image signals are sequentially subjected to various kinds of processing will be described below with reference to FIG. 2.

The control unit 70 is equipped with an image data acquiring unit 71 which is an example image information acquiring unit for acquiring image data (image information) generated for output of an image by the image forming apparatus 1, a line width adjusting unit 72 for adjusting the line widths of characters in the image data, a rasterizing unit 73 for generating a raster image from the image data as adjusted by the line width adjusting unit 72, a color conversion processing unit 74 for converting RGB data into YMCK data, a raster image adjusting unit 75 for adjusting the raster image as subjected to the color conversion by the color conversion processing unit 74, a screen processing unit 76 for performing screen processing, and an image data output unit 77 for outputting the image data as subjected to the image processing.

In the exemplary embodiment, first, the image data acquiring unit 71 receives image data from the external PC. The image data is print data that a user of the PC wants to print using the image forming apparatus 1.

The line width adjusting unit 72 adjusts the line widths of characters in the image data. When a text image is formed by the marking engine, the image formation is affected by a type of a sheet P, environmental conditions such as temperature, and other factors, as a result of which the width (thickness) of the lines that constitute each character may become different from a desired one. Furthermore, the user of the image forming apparatus 1 may want to change the thicknesses of characters according to his or her tastes. In view of the above, in the exemplary embodiment, the line width adjusting unit 72 is provided to adjust the width (thickness) of the lines that constitute each character.

The rasterizing unit 73 rasterizing the image data that are output from the line width adjusting unit 72 into a raster image, that is, raster data of respective pixels. The rasterizing unit 73 outputs the resulting raster data in the form of RGB (red, green, and blue) video data on a page-by-page basis.

The color conversion processing unit 74 converts the RGB data that are input from the rasterizing unit 73 into device-independent color values such as [XYZ], [L*a*b*], or [L*u*v*], converts the latter into YMCK data corresponding to the reproduction colors of the image forming apparatus 1 (i.e., the toner (colorant) colors which are yellow (Y), magenta (M), cyan (C), and black (B)), and outputs the YMCK data. The YMCK data consist of Y-color data, M-color data, C-color data, and K-color data which are separated from each other.

The raster image adjusting unit 75 performs various adjustments such as γ conversion, resolution processing, and halftone processing on the YMCK data that are input from the color conversion processing unit 74 to obtain better image quality in the image forming apparatus 1.

The screen processing unit 76 performs screen processing on the image information, that is, performs dither mask processing using a dither mask which has a predetermined threshold value array defined in the main scanning direction and the auxiliary scanning direction. As a result, for example, the image data are converted into multi-value data into binary data.

The image data output unit 77 outputs the image data as subjected to the image processing such as the color conversion processing to the marking engine.

In printing characters by the marking engine, image data that are acquired from the PC may include text information (text data) and characters to be printed may have bold characters and non-bold characters in mixture. In this case, the image data also include bold characters and non-bold characters in mixture. The bold character is a character in which the width of the lines constituting it is greater than an ordinary thickness. The non-bold character is a character that is not a bold character, that is, a character in which the lines constituting it have an ordinary thickness.

In this situation, the following problem arises if the line width adjusting unit 72 performs the character thickness adjustment uniformly (i.e., irrespective of bold characters and non-bold characters).

Parts (a) to (f) of FIG. 3 illustrate example processing performed by the line width adjusting unit 72. Parts (a) to (f) of FIG. 3 illustrate a character thickness adjustment in a case that character data is of an outline font. The outline font is a font that uses character data in which a character shape is expressed in the form of a collection of sets of coordinates of reference points and outline segments.

In the case of an outline font, character data includes such information as anchor points Ap and direction line control points. As shown in (a) of FIG. 3, an outline is formed using, for example, Bezier curves on the basis of such pieces of information. In the example of (a) of FIG. 3, an outline L is formed for a character “F.”

Where the character thickness is not to be adjusted, the character is completed by filling, in the manner shown in (b) of FIG. 3, the inside of the outline L that has been formed as shown in (a) of FIG. 3.

On the other hand, to perform processing for increasing the character thickness (line width), first, as shown in (c) of FIG. 3, lines (strokes S) having a predetermined width are set so that the outline L becomes their center lines. The degree of thickening of the character lines can be adjusted by adjusting the width of the strokes S.

Then connecting points of the strokes S are adjusted to obtain a character shown in (d) of FIG. 3 in which Sout and Sin denote outside edges and inside edges of the strokes S, respectively.

As shown in (e) of FIG. 3, the character can be thickened by filling the inside of the outside edges Sout of the strokes S.

On the other hand, as shown in (f) of FIG. 3, the character can be thinned (the line width can be decreased) by filling the inside of the inside edges Sin of the strokes S.

If this adjustment is performed in such a manner that the width of a stroke S is set the same for both of bold characters and non-bold characters and the character thickness is increased uniformly, resulting bold characters are made less recognizable as bold characters (i.e., they become less noticeable) than before the character thickening because the ratio of the line width of bold characters to that of non-bold characters becomes smaller.

This will be explained below using a specific example. Assume a non-bold character having a line width of 4 dots (pixels) and a bold character having a line width of 6 dots. If both characters are thickened by 2 dots, the non-bold character and the bold character come to have line widths of 6 dots and 8 dots, respectively. Whereas the ratio of the line width of the bold character to that of the non-bold character before the thickening is 6/4=1.5, the ratio after the thickening is 8/6≅1.33. The ratio is thus made smaller by the thickening.

On the other hand, if an adjustment is performed in such a manner that the width of a stroke S is set the same for both of bold characters and non-bold characters and the character thickness is decreased uniformly, resulting bold characters look as if to stand out, that is, become too noticeable, because the ratio of the line width of bold characters to that of non-bold characters becomes larger than before the character thinning.

This will be explained below using a specific example. Assume a non-bold character having a line width of 4 dots (pixels) and a bold character having a line width of 6 dots. If both characters are thinned by 1 dot, the non-bold character and the bold character come to have line widths of 3 dots and 5 dots, respectively. Whereas the ratio of the line width of the bold character to that of the non-bold character before the thinning is 6/4=1.5, the ratio after the thinning is 5/3≅1.67. The ratio is thus made larger by the thinning.

Parts (a) to (d) of FIG. 4 show how character shapes are changed when a bold character “F” and a non-bold character “F” are subjected to uniform character thickening processing. Parts (a) and (b) of FIG. 4 show the bold character “F” and the non-bold character “F” before being subjected to the character thickening.

Parts (c) and (d) of FIG. 4 show results of a uniform character thickening adjustment (the width of a stroke S is set the same) performed on the characters shown in (a) and (b) of FIG. 4. It is seen from (a) and (b) of FIG. 4 that before the character thickening the bold character is more noticeable and recognizable. On the other hand, it is seen from (c) and (d) of FIG. 4 that after the character thickening (i.e., after the adjustment) the bold character is not very noticeable, that is, the line width of the bold character looks not much different from that of the non-bold character.

It is understood from the above description that adjusted characters prone to become unnatural if the ratio between the line width of bold characters to that of non-bold characters is changed by a character thickness adjustment. It is therefore desirable that the change of this ratio be kept as small as possible in making a character thickness adjustment.

The exemplary embodiment suppresses the above-described problem by the line width adjusting unit 72 having the following configuration.

### Line Width Adjusting Unit

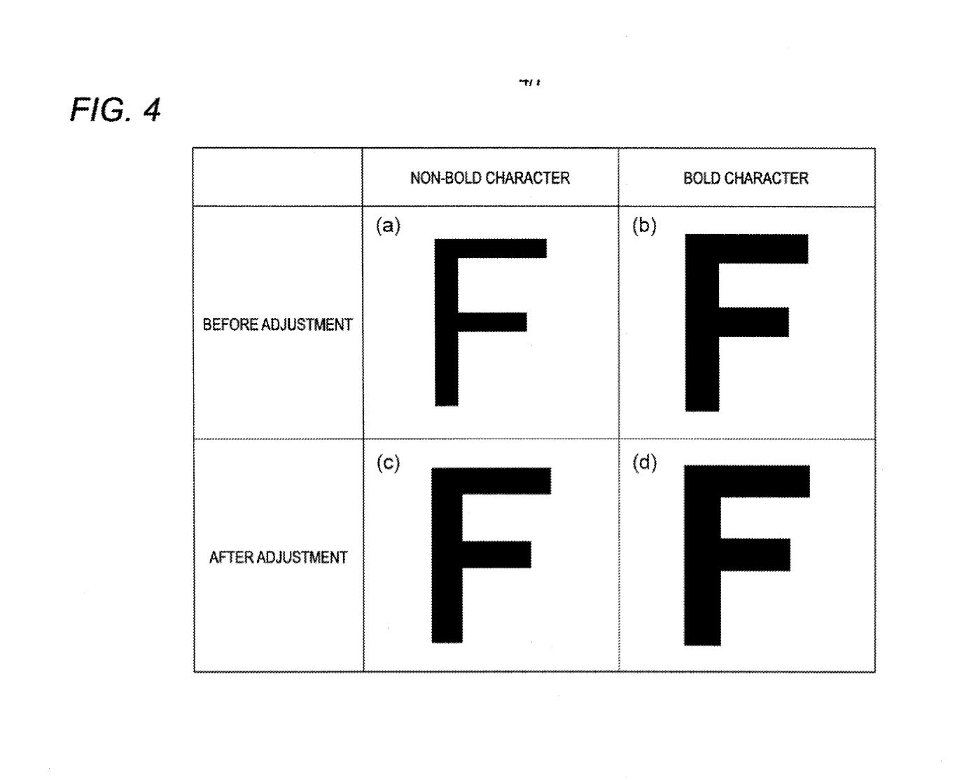

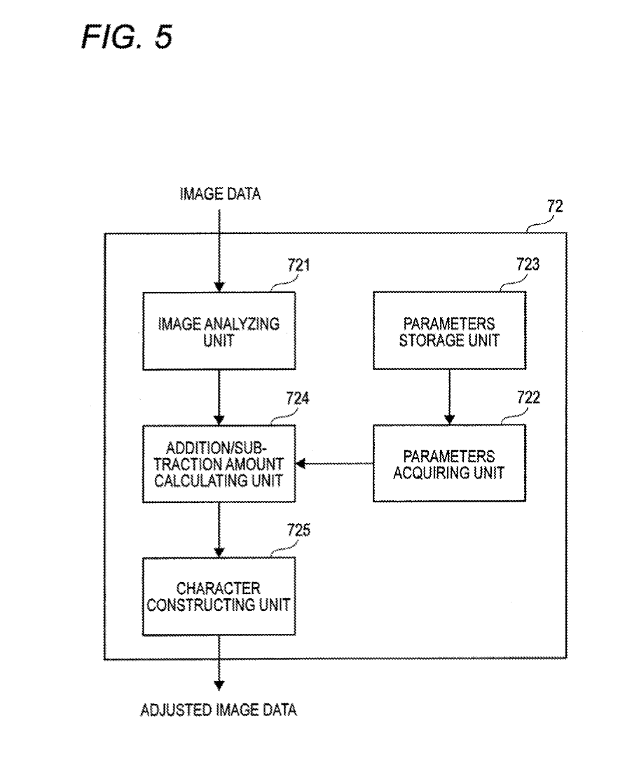

FIG. 5 is a block diagram of the line width adjusting unit 72 used in the exemplary embodiment. As shown in FIG. 5, the line width adjusting unit 72 is equipped with an image analyzing unit 721, a parameters acquiring unit 722, a parameters storage unit 723, an addition/subtraction amounts calculating unit 724, and a character constructing unit 725.

The image analyzing unit 721 analyzes image data acquired by the image data acquiring unit 71 (see FIG. 2) and judges whether or not the image data include character data.

The parameters acquiring unit 722 acquires parameters to be used for calculating addition/subtraction amounts for character thickness adjustment that are stored in the parameters storage unit 723. The parameters acquiring unit 722 reads those parameters from the parameters storage unit 723.

The addition/subtraction amounts calculating unit 124 calculates addition/subtraction amounts which indicate degrees of character thickness adjustment. For example, the addition/subtraction amounts calculating unit 724 calculates an addition/subtraction amount W1 for non-bold characters and an addition/subtraction amount W2 for bold characters according to Equations (1) and (2), respectively. In Equations (1) and (2), X represents a specified value indicating to what extent characters should be thickened or thinned and α and β are constants. X, α, and β are the parameters to be acquired by the parameters acquiring unit 722. The addition/subtraction direction is determined by whether X is a positive number of negative number.

For non-bold characters:

W1=|X|×α (1)

For bold characters:

W2=|X|×α+(font size)×β (2)

When X is a positive number, a character is thickened by filling the inside of outside edges Sout. Since α and β are positive numbers, W1 is smaller than W2 in the case of thickening characters. Therefore, the degree of thickening (line width increase) of bold characters is higher than that of non-bold characters. As a result, the change of the ratio that was described above with reference to (a) to (f) FIG. 3 is kept small and bold characters are kept as noticeable as before the character thickening.

When X is a negative number, a character is thinned by filling the inside of inside edges Sin. Also in the case of thinning characters, W1 is smaller than W2 (W1 and W2 are positive numbers). Therefore, the degree of thinning (line width decrease) of bold characters is higher than that of non-bold characters. As a result, the change of the ratio that was described above with reference to (a) to (f) FIG. 3 is kept small and bold characters do not become too noticeable even after the character thinning.

In the exemplary embodiment, the value of W2 varies depending on the font size. That is, the difference between W1 and W2 (W2−W1) increases as the font size increases. The ratio that was described above with reference to (a) to (f) FIG. 3 is not maintained unless W2 is increased and the degree of character thickening or thinning is thereby increased as the font size increases.

In the above-described example, the parameters are determined in advance according to a type of a sheet P, environmental conditions such as temperature, and other factors and are stored in the parameters storage unit 723. That is, the parameters acquiring unit 722 selects values of the parameters X, α, and β according to a type of a sheet P, environmental conditions such as temperature, and other factors and the addition/subtraction amounts calculating unit 724 calculates addition/subtraction amounts W1 and W2.

On the other hand, where the character thicknesses are to be changed according to the tastes of a user of the image forming apparatus 1, the image forming apparatus 1 may be configured so that the user inputs a parameter value (e.g., a value of the parameter X) through a user interface unit (UI unit; not shown) of the image forming apparatus 1.

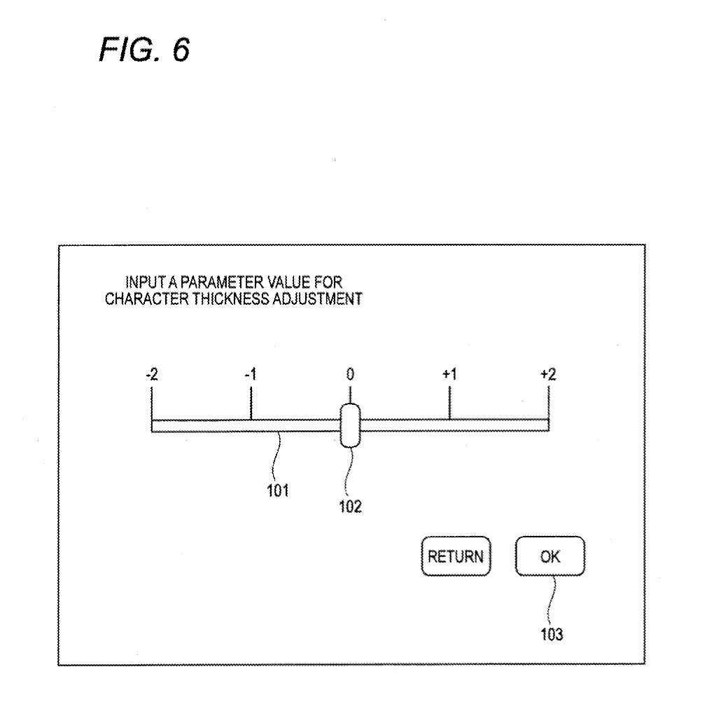

FIG. 6 shows an example picture that is displayed on the UI unit when a user is to input a value of the parameter X. In this case, the UI unit is a touch screen. A message “Input a parameter value for character thickness adjustment” is displayed at the top of the picture. A slide bar 101 and a slider 102 for input of a parameter value are displayed under the message. The slider 102 can slide along the slide bar 101 in the left-right direction in FIG. 6 as the user manipulates it. In the initial state, the slider 102 is located at the center of the slide bar 101, which means that the parameter X is equal to “0” (i.e., a value before a character thickness adjustment).

The value of the parameter X varies as the user slides the slider 102 leftward or rightward along the slide bar 101 while touching the screen. In this example, the parameter X can be varied between “−2” and “+2.” If a positive value is specified for the parameter X, characters are thickened; they are thickened more when a larger value is specified for the parameter X. Conversely, if a negative value is specified for the parameter X, characters are thinned; they are thinned more when a smaller value is specified for the parameter X.

After specifying a value of the parameter X, the user touches an OK button 103 as a last manipulation, whereupon the parameter X is determined. The parameters acquiring unit 722 acquires the user-input value of the parameter X.

In the example of FIG. 6, a user inputs a value of the parameter X and values of the parameters α and β are stored in the parameters storage unit 723. However, the image forming apparatus 1 so as to allow a user to also input values of the parameters α and β.

Returning to FIG. 5, the character constructing unit 725 constructs characters by the method that was described with reference to (a) to (f) of FIG. 3. In doing so, the character constructing unit 725 adjusts the width of strokes S according to addition/subtraction amounts W1 and W2 calculated by the addition/subtraction amounts calculating unit 724, that is, increases the width of strokes S as the addition/subtraction amount W1 or W2 increases.

### Operation of Line Width Adjusting Unit

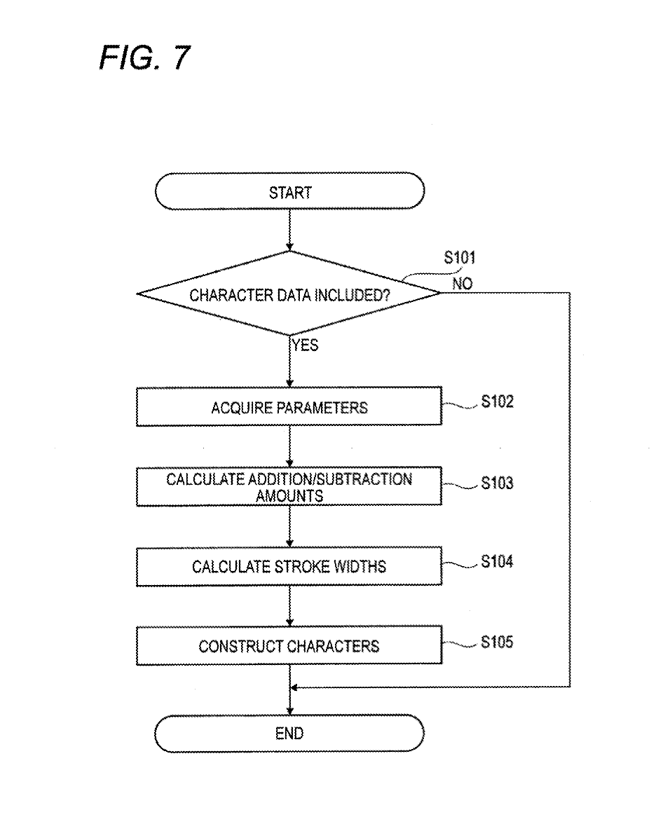

FIG. 7 is a flowchart showing how the line width adjusting unit 72 operates. How the line width adjusting unit 72 operates will be described below with reference to FIGS. 5 and 7.

First, at step S101, the image analyzing unit 721 analyzes image data acquired by the image data acquiring unit 71 (see FIG. 2) and judges whether or not the image data include character data. If the image data do not include character data (S101: no), the process is finished.

On the other hand, if the image data include character data (S101: yes), at step S102 the parameters acquiring unit 722 acquires parameters for calculating addition/subtraction amounts for character thickness adjustment. Where the above-described Equations (1) and (2) are used to calculate addition/subtraction amounts W1 and W2 for character thickness adjustment, the parameters acquiring unit 722 acquires the parameters X, α, and β. The parameters acquiring unit 722 may either acquire the parameters X, α, and β from the parameters storage unit 723 as described above or acquire values that are input by a user through the UI unit or the like.

At step S103, the addition/subtraction amounts calculating unit 724 calculates addition/subtraction amounts W1 and W2 indicating degrees of character thickness adjustment by, for example, substituting the parameters X, α, and β into Equations (1) and (2).

At step S104, the character constructing unit 725 calculates widths of strokes S for bold characters and non-bold characters, respectively. At step S105, the character constructing unit 725 constructs characters by the method that was described above with reference to (a) to (f) of FIG. 3.

Image data of the constructed characters are output to the rasterizing unit 73 (see FIG. 2). The image data are subjected to the various kinds of image processing that were described above with reference to FIG. 2. Resulting image data are output to the marking engine and an image formed there.

As described above, the control unit 70 of the exemplary embodiment can be recognized as an image processing apparatus which is equipped with the image data acquiring unit 71 for acquiring image data for formation of an image by the marking engine and the line width adjusting unit 72 for setting different addition/subtraction amounts for the thickness of lines constituting bold characters and the thickness of lines constituting non-bold characters in changing the thickness of lines constituting each character in the case where the image data include bold character information and non-bold character information.

In the method described above in detail, an adjustment for increasing the thickness of the line width of each character is performed so that the degree of character thickening for bold characters is made higher than that for non-bold characters. This suppresses the problem that adjusted bold characters become less discernible.

On the other hand, an adjustment for decreasing the thickness of the line width of each character is performed so that the degree of character thinning for bold characters is made higher than that for non-bold characters. This suppresses the problem that adjusted bold characters become too noticeable.

Thus, in the exemplary embodiment, when a character line width adjustment is performed, the change of the ratio of the width of lines constituting bold characters to that of lines constituting non-bold characters is kept small and hence adjusted characters are less prone to become unnatural.

Although the exemplary embodiment is directed to the electrophotographic image forming apparatus 1, the invention is not limited to such a case and can also be applied to inkjet image forming apparatus, for example.

Although in the exemplary embodiment a character line width adjustment, is performed according to a type of a sheet P and environmental conditions such as temperature (and a user instruction), the invention is not limited to such a case. For example, a character line width adjustment may be performed according to a character image density, a font type, or the like.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

1. An image forming apparatus comprising:
an image data acquiring unit that acquires image information;
a line width adjusting unit that adjusts a thickness of lines constituting a character that is included in the image information acquired by the image data acquiring unit; and
an image forming machine that forms an image on a recording material based on the image information as adjusted by the line width adjusting unit; wherein
the line width adjusting unit comprises an addition/subtraction amounts calculating unit that calculates addition/subtraction amounts which indicate degrees of changing of the thickness of lines constituting characters, and
the addition/subtraction amounts calculating unit calculates the addition/subtraction amounts in a manner such that the addition/subtraction amount for a thickness of lines constituting bold characters and the addition/subtraction amount for a thickness of lines constituting non-bold characters are different from each other in a case in which both bold character information and non-bold character information are included in the image information acquired by the image data acquiring unit.

2. The image forming apparatus according to claim 1, wherein the addition/subtraction amount for bold characters is set larger than that for non-bold characters in both cases of increasing the thickness of lines constituting each character and decreasing the thickness of lines constituting each character.

3. The image forming apparatus according to claim 1, wherein the addition/subtraction amount for bold characters is set larger when a character size is larger.

4. The image forming apparatus according to claim 2, wherein the addition/subtraction-amount for bold characters is set larger when a character size is larger.

5. The image forming apparatus according to claim 1, wherein the bold characters and the non-bold characters are of an outline font.

6. The image forming apparatus according to claim 2, wherein the bold characters and the non-bold characters are of an outline font.

7. The image forming apparatus according to claim 3, wherein the bold characters and the non-bold characters are of an outline font.

8. The image forming apparatus according to claim 4, wherein the bold characters and the non-bold characters are of an outline font.

9. An image processing apparatus comprising:
an image data acquiring unit that acquires image information for formation of an image by an image forming machine that forms an image on a recording material;
a line width adjusting unit that adjusts a thickness of lines constituting a character that is included in the image information acquired by the image data acquiring unit; wherein
the line width adjusting unit comprises an addition/subtraction amounts calculating unit that calculates addition/subtraction amounts which indicate degrees of changing of the thickness of lines constituting characters,
the addition/subtraction amounts calculating unit calculates the addition/subtraction amounts in a manner such that the addition/subtraction amount for a thickness of lines constituting bold characters and the addition/subtraction amount for a thickness of lines constituting non-bold characters are different from each other in a case in which both bold character information and non-bold character information are included in the image information acquired by the image data acquiring unit, and
the image forming machine forms the image on the recording material based on the image information as adjusted by the line width adjusting unit.
